(19) United States
(12) Patent Application Publication
(10) Pub. No.: US 2023/0245519 A1
(43) Pub. Date: Aug. 3, 2023

(54) DEVICE FOR DISTRIBUTING STAND-UP PADDLE BOARDS AND ITS METHOD

(71) Applicant: SUPBORN S.N.C. DI MARCO MARCONICCHIO & AYMERIC SEVENET, Verona (IT)

(72) Inventors: Marco Marconicchio, Verona (IT); Aymeric Francois Pierre Sevenet, Verona (IT)

(73) Assignee: SUPBORN S.N.C. DI MARCO MARCONICCHIO & AYMERIC SEVENET, Verona (IT)

(21) Appl. No.: 18/009,736

(22) PCT Filed: Jun. 15, 2021
(86) PCT No.: PCT/IB2021/055272

§ 371 Date: Dec. 12, 2022

(30) Foreign Application Priority Data
Jun. 16, 2020 (IT) 102020000014281

(51) Int. Cl. G07F 11/64; B63B 32/83; H02S 10/00

(52) U.S. Cl. CPC G07F 11/64; B63B 32/83; H02S 10/00

(57) ABSTRACT

A device (100) for dispensing a “stand up paddle” (SUP) board comprises a side cover (5) resting on a circular lower base (6), wherein inside the side cover (5) is contained at least one board (1), and an upper cover (9) said device (100) being characterized in that said side cover (5) comprises at least one door (2) for dispensing the board (1), a drawer (3) positioned below the door (2) for dispensing the complementary elements (4) for practicing “stand up paddle” (SUP), and a control means (7) configured for checking the availability of the at least one board (1) and for the controlled opening of the door (2) and the drawer (3).

### BACKGROUND OF THE INVENTION

### 1. Field of the Invention

The present invention relates to a device for distributing “stand up paddle” (SUP) boards through a rental service and to a method for dispensing the boards connected thereto.

### 2. Brief Description of the Prior Art

As is well known SUP is the term used to mean “you stand on a board” and move around using a paddle in the water. SUP is the meeting point between Surfing and Canoeing, from Surfing it takes the characteristic of sliding on the water standing on a board and being able to ride the waves and from Canoeing it inherits the paddle, with which you paddle standing up.

According to the well-known art, the main difference between a SUP board and a classic surfboard is definitely the size, in fact the SUP board can extend up to twice or even three times the size of a normal wave surfboard, this allows for greater stability, but the real innovation is the use of the paddle, which allows you to surf safely (while standing).

The growth of this discipline is very high; every year the manufacturers, in view of the demand from increasingly demanding enthusiasts, has led to the creation of materials aimed at innovation and the most modern technologies such as the use of carbon paddles and continuous research dedicated to lightening the boards and also to the creation of inflatable boards that can be easily transported and adapted to all situations. This sport is now very popular in Italy, where there are hundreds of people practising it, because it is simple and accessible to everyone. This technique is suitable for all ‘water’ surfaces, from the calmest (lake) to the liveliest (sea or river).

Typically, as these boards are large, they are difficult to transport. In addition, it is extremely important to monitor the presence of these boards in places where they are used, particularly for safety reasons. In addition, since this is a relatively new sport, in order to introduce it to interested users and give them a chance to try it out, it is extremely important to set up distributors for board hire, located in the immediate vicinity of places where the sport can be practiced.

There are no known distributors of stand-up paddle boards, nor a method for dispensing such boards.

### SUMMARY OF THE INVENTION

The aim of the present invention is to create devices for distributing stand up paddle (SUP) boards which are practical and easy to use for a rental service. According to the invention, the solution relates to the creation of a device for distributing boards and a method for dispensing said boards. In particular, the invention creates a device for distributing vertical boards, extremely compact and easy to transport and position, which, thanks to a software application connected to it, manages the dispensing, the return and the use of the board by a user, without the need for personnel present near the device. Advantageously, the compactness of the device object of the present invention is ensured by arranging the boards radially with respect to an axis passing through the centre of symmetry of the device.

Advantageously, the method for dispensing the boards also performs a monitoring of the area in which the board is used, to ensure safety to the user.

Therefore, according to the present invention a device for dispensing “stand up paddle” boards according to the features set forth in the independent product claim is provided.

According to the present invention, there is also described a method for dispensing said boards, the method having the characteristics set forth in the independent claim appended hereto.

Further preferred and/or particularly advantageous embodiments of the invention are described according to the features set forth in the appended dependent claims.

### BRIEF DESCRIPTION OF THE DRAWINGS

The invention will now be described with reference to the appended drawings, which illustrate a non-limiting example implementation, wherein:

FIG. 1 is an overall view of the device for dispensing “stand up paddle” boards according to the present invention,

FIG. 2 shows the material dispensed by the device of FIG. 1 according to the present invention,

FIG. 3 is a relational graph of the method for operating the device of FIG. 1,

FIG. 4 is a flow chart of the method according to FIG. 3;

FIG. 5 is an overview of the stand-up paddle device according to FIG. 1 with the integration of solar panels.

### DETAILED DESCRIPTION OF THE PREFERRED EMBODIMENTS

By way of non-limiting example, the present invention will now be described with reference to an innovative device 100 for distributing “stand up paddle” (SUP) boards and a method for dispensing and handling the boards connected thereto. The attached figures show a purely illustrative configuration of the invention.

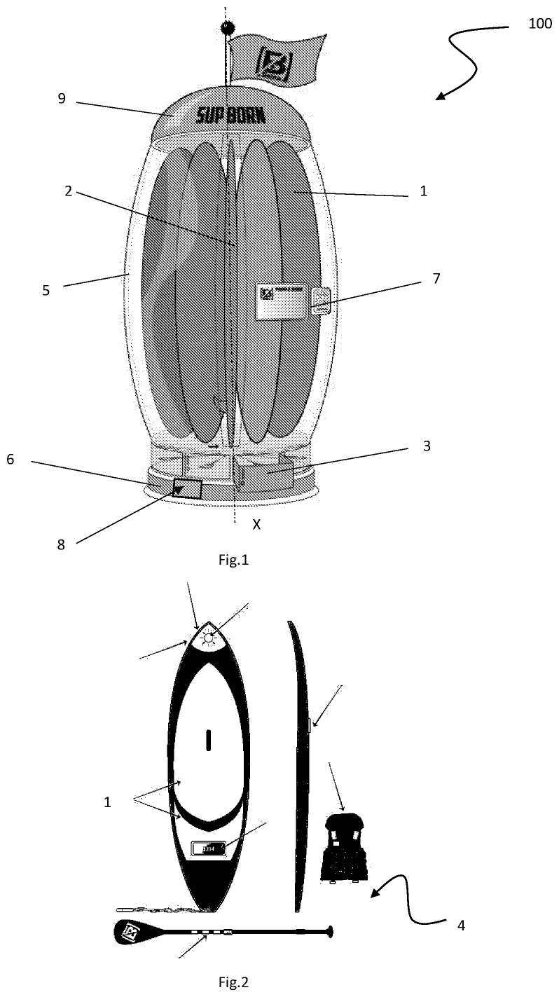

With reference to FIG. 1, the device 100 for dispensing boards according to a preferred embodiment of the invention comprises a side cover 5 of a nearly elliptical shape, resting on a circular lower base 6 and an upper cover 9. Inside the side cover 5 is contained at least one “stand up paddle” (SUP) board 1 and the side cover 5 itself has at least one vertical door 2 for dispensing the board 1, a drawer 3 positioned below the door 2 for dispensing the complementary elements 4 for the practice of SUP and a control means 7 for checking the availability of the boards and for the controlled opening of the at least one door 2 and the drawer 3.

As shown in FIG. 2, the complementary elements 4 include, for example, a paddle, a life jacket, etc. used for the practice of the sport. Advantageously, the life jacket is equipped with GPS and a special button for sending an SOS.

In the event of an actual emergency, the local public or private rescue service will be alerted. This will provide double safety: the person in the water and the rental property.

As shown in FIG. 1, device 100 is equipped with an automatic external defibrillator (AED) 8, preferably located in its lower portion, which is provided free of charge to the public. The AED 8 is placed in a transparent, glass-breakable drawer that is easily accessible to the person in case of need.

Conveniently, in the event of an emergency, there is a real operations room with qualified medical staff and connected to the national emergency number 118. By means of a central computer the medical personnel, dedicated and specifically hired for the system 100 of the present invention, immediately interfaces with the user in an emergency. In case of rescue in water, it is able to lead the rescuer towards the person in the water, with extreme precision, thanks to the geo-localization system. Moreover, in case of rescue, a unit equipped with an inflatable boat with private medical personnel interconnected to the operations room will be available during the entire working day, to support the user and the citizenship in the territory of application of the system 100.

Advantageously, the device 100 is controlled by specialized technical personnel for the maintenance and safety of the machinery and materials used, for carrying out the work.

Advantageously, the board distribution device 100 further comprises a voice device connected to the operation room to support persons who need help in picking up and returning the board.

Advantageously, the board 1 can be monitored in real time to handle any emergency and can also be fitted with a light device to alert the user to return immediately in the event of sudden adverse weather. Real-time monitoring can handle any emergency in case of sudden adverse weather. The boards 1 contained in a device 100 are variable in number from

1 to 50. In a preferred configuration, the number of boards is 10 and the side cover 5 has two vertical flaps 2 arranged at 180° to each other for the simultaneous dispensing of two boards 1, so as to allow at least two users at a time, to access the boards 1.

Said boards may be either rigid or inflatable. The arrangement of said boards 1 within the device 100 is radial with respect to an axis X passing through the centre of symmetry of the device 100, so as to ensure extreme compactness and the smallest possible size of the device 100.

Advantageously, the structure of the device 100 is made entirely of environmentally friendly materials, since the device can also be installed in landscape protected areas. In particular, device 100 can be made of the most suitable materials in relation to local regulations and provisions. For example, it can be made entirely of recycled material or wood for the external structures, reeds for the roof and, in any case, it can be made in any color to be integrated with the nature or landscape in which it is to be integrated. Advantageously, the device 100 may be made transparent in colour, in order to allow the number of board 1 available inside it to be immediately seen.

As shown in FIG. 5, the device 100 can be electrically powered by means of a plurality of photovoltaic panels 10 positioned on the upper cover 9 of the device and an electric cable that will allow to transfer to the network the energy not used during the daytime hours and to power the structure during the nighttime hours.

Energy storage batteries are also provided. The support 90′ of the photovoltaic panels 10 is swivelling, in order to allow the maximum performance of the panels themselves, depending on where it is positioned.

In addition, underneath the control means 7 there is a space for the sale of SUP accessories, such as, for example: swimming costumes, goggles, sun cream, bandanas, hats, towels, etc. This can be done either directly from the control unit or by using a computer. This can be done either directly with your smartphone or manually using a keypad on Control means 7. Payment is always by credit card.

Advantageously, above the keyboard 70 of the control means 7 there is a monitor 80 and in the upper part of the device 100 a banner 90, both of which are available as advertising space. In addition, an RFID reader will also be positioned above the control medium.

The dimensions of the device 100 are preferably between 3 and 4 m in height, between 2 and 3 m in width, between 2 and 3 m in depth. The diameter of the base is preferably between 2 and 3 meters. Even more preferably, the height is 3.50 meters, the length 2.50 meters, the depth 2.50 meters and the base diameter 2.50 meters. In this case, the number of boards 1 contained in the device 100 is preferably equal to 10 boards.

Advantageously, the dimensions of the device 100 are such that it can be easily transported by road, by means of a normal transport truck, already completely assembled.

Advantageously, the upper wall of the device 100 will be provided with a lifting eyebolt for positioning on the ground by means of a crane arm.

Advantageously, the positioning on the ground of the device 100 does not require any anchoring holes, but will be ensured by a few levelling feet, at most it may be necessary to insert sand, gravel, or other material in appropriate compartments of the circular lower base 6 of the device 100, to ensure its stability in particularly windy areas.

Advantageously, the circular lower base 6 of the device 100, in addition to serving as a base, will be shaped so as to be able to easily collect and evacuate any residual water, sand or gravel present on the board 1.

Advantageously, a compressor (of known type and therefore not shown in the attached figures) will be positioned inside the circular lower base 6 to facilitate maintenance and cleaning of the compartments.

Advantageously, at least one surveillance camera (webcam) will be positioned outside device 100 so as to be able to record and send images of the area of use of the boards 1 directly to the operations room and via the rental application. In addition, the device 100 will include one or more music speakers to play music at certain times of the day.

Advantageously, the board 1 will be equipped with a digital camera positioned on the face in contact with the water for monitoring the seabed/water for the possible intervention of waste removal on the seabed for the protection of the territory. This camera has the function of scanning and sending the images on an iCloud, with the main purpose of intervening for the reclamation of the seabed in the places where the boards 1 are used.

Advantageously, each board 1, also includes a “TAG Radio Frequency Identification” (RFID), which allows, by approaching the board to an RFID reader, to automatically unlock the opening of its door.

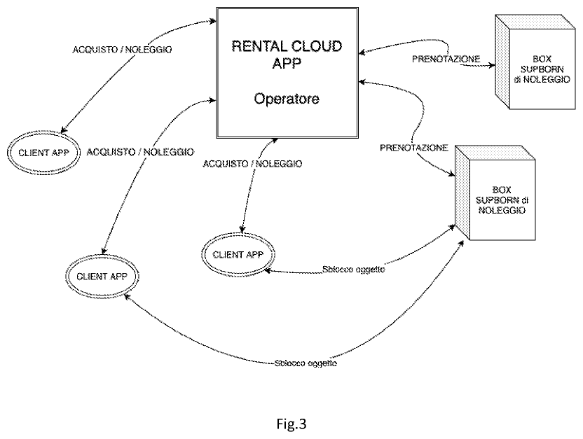

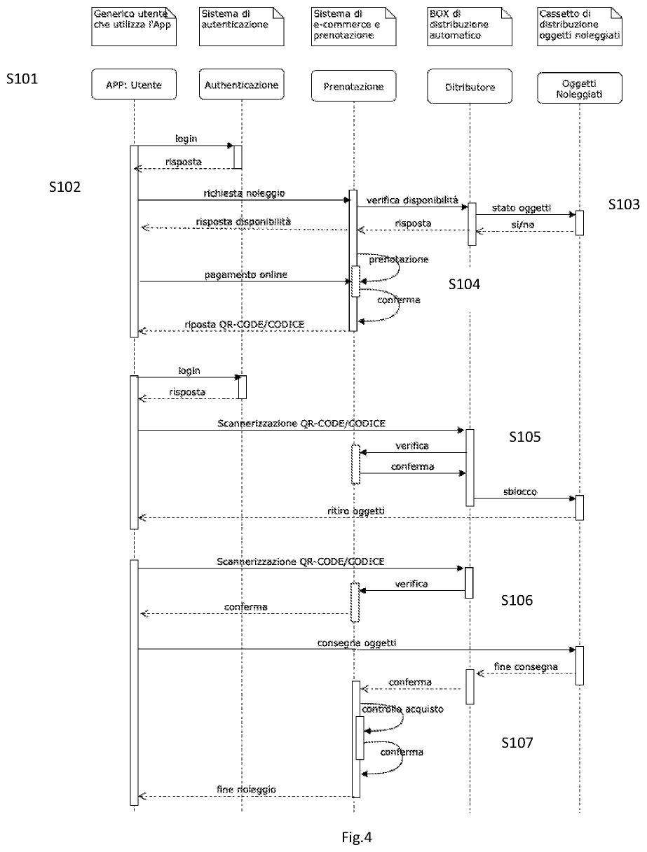

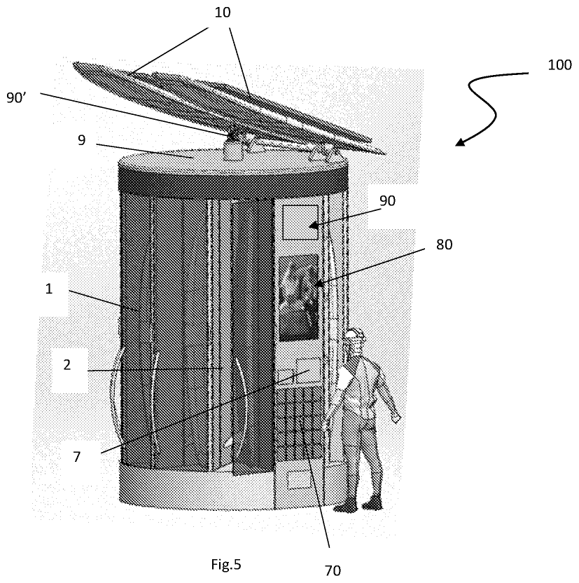

In this way, the user will no longer need to have the smartphone at hand to return the material. With reference to FIG. 3 and FIG. 4, the new method of operating the device 100 will now be presented.

Typically, all sports that are practiced in an aquatic environment need technologies connected to it to support the user in the water in case of danger, accident, by means of specialized medical support.

The method for operating the device 100 is aimed at monitoring and geolocating users who have rented a board 1 from the device 100 object of the present invention.

The novel method for operating the device 100, starts with a first step S101: downloading a dedicated software application by means of a user registration via their electronic device and creating a password to ensure the security of the application access (authentication).

Following installation of the software application and password authentication, the method is also configured to allow the user to: b. S102 requesting the availability of a board, by sending the request from his mobile device directly from the software application to a special software installed on the same device 100; c. S103 getting a YES/NO answer on his mobile phone about the availability of the board 1; d. S104 making a reservation of board 1, receiving the booking confirmation, making the payment and receiving the relevant QR-Code; e. S105 scanning the QR-Code and verifying it by means of a QR-Code reader placed on the device 100; f. S106 dispensing and delivering board 1 and complementary items 4; g. S107 checking the congruence between purchase and returning of the board and the complementary elements.

Furthermore, according to the present invention it is envisaged that the user, following the booking, made through the software application described above and the consequent payment, receives on his mobile phone or smartphone a QR code that will be read by the QR code reader positioned on the device 100, preferably near the control means 7. Once the QR code has been read and the rental has been verified, the number of the compartment in which the material is to be taken (board, paddle, jacket—also with a geo localization system—and ankle-strap) will appear on the monitor of device 100 and the corresponding door 2 will automatically unlock through an electric lock. The user can then start using the SUP once the equipment has been removed and the door closed again.

Once the rental time is over, considering that the rental will end when all the material is reinserted inside the compartment of the device and the consequent re-closing of door 2, the user will return near the distribution device of the boards 1, where there are at least two Radio Frequency Identification RFID readers. Having each board, on one side, inserted an RFID TAG, approaching the board to the RFID reader, this will allow the unlocking of the opening of the correct door 2. In this way, the user will no longer need to have a smartphone handy to return all the material used. First of all, it is necessary to store the board 1 by inserting it in a position predetermined by form supports, then a cable for recharging the instrumentation located on board the board is connected to the board. Then the user will find, indicated by pictograms, the position to store the accessories: paddle, jacket (including the insertion of the recharge cable, as it contains the geo-localisation system) and ankle strap.

In order to end the rental, with the associated termination of liability for the rented equipment, the user must check that a confirmation light, LED light, comes on before closing door 2. This LED will verify that everything rented has been returned and connected for recharging.

Advantageously, once the door is closed, a sanitization cycle for the material will start, using UV-C lamps located on the sides of the material compartment.

Advantageously, rental is also carried out directly on the device via the keyboard 70 of control means 7. This method could create queues when accessing the device, so signs will be provided to avoid crowds and encourage the use of the application. Advantageously, the software connected to the application is developed as proprietary software.

In addition to the form of embodiment of the invention as described above, it must be understood that there are numerous other variations. It should also be understood that these forms of embodiment are only illustrative and do not limit either the scope of the invention, its applications or its possible configurations. On the contrary, although the above description enables the skilled person to implement the present invention according to at least one exemplary embodiment thereof, it should be understood that many variants of the described components are possible without departing from the scope of the invention as defined in the appended claims, which are interpreted literally and/or according to their legal equivalents.

1. A device (100) for dispensing a “stand up paddle” (SUP) board comprises a side cover (5) resting on a circular lower base (6), wherein inside the side cover (5) is contained at least one board (1), and an upper cover (9) said device (100) being characterized in that said side cover (5) comprises at least one door (2) for dispensing the board (1), a drawer (3) positioned below the door (2) for dispensing the complementary elements (4) for practicing “stand up paddle” (SUP), and a control means (7) configured for checking the availability of the at least one board (1) and for the controlled opening of the door (2) and the drawer (3).

2. The device (100) according to claim 1, wherein said side cover (5) has two flaps (2) arranged at 180° to each other, for the simultaneous dispensing of two board (1).

3. The device (100) according to claim 1, wherein said device (100) has a height of between 3 m and 4 m, a length of between 2 m and 3 m, a depth of between 2 m and 3 m and a diameter of the base is between 2 m and 3 m.

4. The device (100) according to claim 3, wherein said device (100) has a height of 3.50 m, a length of 2.50 m, a depth of 2.50 m and a base diameter of 2.50 m.

5. The device (100) according to claim 1, wherein the number of the at least one board (1) that can be contained is between 1 and 50.

6. The device (100) according to claim 5, wherein the number of the at least one board (1) that can be contained is 10.

7. The device (100) according to claim 1, wherein the side cover (5) is elliptical in shape and transparent in color.

8. The device (100) according to claim 1, wherein the at least one board (1) is arranged in a radial position with respect to an axis (X) passing through the center of symmetry of said device (100).

9. The device (100) according to claim 1, wherein said upper cover (9) of said device (100) comprises a plurality of photovoltaic panels (10) electrically supplying said device.

10. The device (100) according to claim 1, further comprising a monitor (80), a banner (90), both available as advertising space, and a “Radio Frequency Identification” (RFID) reader.

11. The device (100) according to claim 1, wherein the circular lower base (6), in addition to serving as a base, is shaped so as to be able to easily collect and evacuate any residual water, sand or gravel present on the at least one board (1).

12. A method for operating the device (100) as described by claim 1, comprising the steps:
a. downloading a dedicated software application by means of a user registration via one's electronic device and creating a password to ensure the security of the application access (authentication) and related QR-Code;
b. requesting the availability of a board, by sending the request from one's mobile device directly from the software application to a dedicated software installed on the device (100) itself;
c. obtaining a YES/NO answer on your mobile phone regarding the availability of the board (1);
d. making a reservation of the board (1), receiving the reservation confirmation, making the payment and receiving the relevant QR-Code;
e. scanning a QR-Code and verifying it by the control means (7) positioned on the device (100);
f. dispensing and delivering the board (1) and the complementary elements (4);
g. checking consistency between purchase and returning of board (1) and complementary elements (4).
